(19) United States
(12) Patent Application Publication
(10) Pub. No.: US 2006/0145820 A1
(43) Pub. Date: Jul. 6, 2006

(54) Cap timing switching

(76) Inventor: Roger M. Rosche, Singapore (SG)

Correspondence Address: FISH & RICHARDSON PC, P.O. BOX 1022, MINNEAPOLIS, MN, 55440-1022, US

(21) Appl. No.: 11/026,976

(22) Filed: Dec. 30, 2004

(51) Int. Cl. G08B 1/00; G08B 21/00

(52) U.S. Cl. 340/309.16; 340/686.1

(57) ABSTRACT

A cap with a timing circuit carries a switch engaged by a pin whose position is representative of when the cap closes a receptacle.

This invention relates to a cap for selectively closing a medication container and having a timing circuit responsive to a switch in the cap that moves between a normally open cap and a closed cap position.

### BACKGROUND OF THE INVENTION

For background reference is made to U.S. Pat. Nos. 5,016,230 and 6,084,504 incorporated by reference herein.

### BRIEF SUMMARY OF THE INVENTION

According to the invention, there is a cap for selectively covering a receptacle. The cap includes a printed circuit with a switch pin that mechanically senses when the cap is in a position securely closing the receptacle and when it is not. According to one aspect of the invention, the switch pin is centrally located in the cap in a switch housing that is on the printed circuit board and engages a sealing member when the cap is in a second position fully closing the receptacle and a first position when the cap does not fully close the receptacle. In another aspect of the invention, the pin is located near the perimeter of the cap, and engages the top of the receptacle when fully closed and is away from the top of the receptacle when not fully closed.

It is an important object of the invention to provide an improved timing cap.

Other features, objects and advantages of the invention will become apparent from the following description when read in connection with the accompanying drawing in which:

### BRIEF DESCRIPTION OF THE SEVERAL VIEWS OF THE DRAWING

FIG. 1 is a diametrical view of a cap according to the invention with a switch pin in a first position;

FIG. 2 is a diametrical sectional view of the cap of FIG. 1 seated on and closing a receptacle; and.

FIG. 3 is a diametrical sectional view of another embodiment of the invention with a switch pin near the perimeter of the cap

Like reference symbols in the various views indicate like elements.

### DETAILED DESCRIPTION

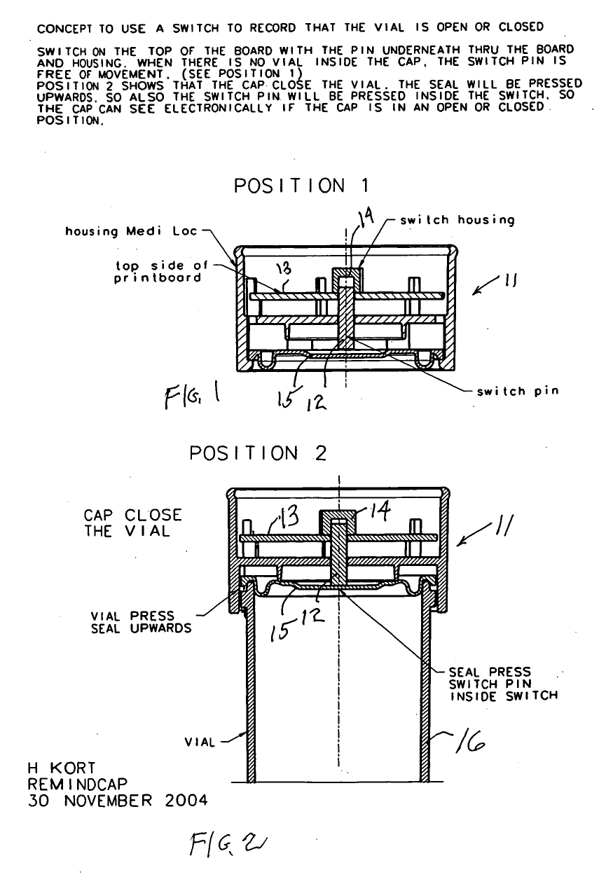

With reference now to the drawing and more particularly FIG. 1 thereof, there is shown a diametrical sectional view of a cap 11 with a central switch pin 12 in a first position with the cap off the receptacle. Cap 11 includes a printed circuit board 13 having timing circuitry of the type disclosed in the aforesaid patents constructed and arranged to initiate a timing cycle when cap 11 closes a receptacle and stop emitting sensible signals when cap 11 is removed from the receptacle, typically indicating that a patient has taken a medication in the receptacle. Printed circuit board 13 carries switch housing 14 in which the top of switch pin 12 resides so that switch pin 12 may actuate a switch (not shown) in switch housing 14 representative of whether the cap closes or does not close the receptacle. The specific switch structure may take numerous forms, evident to those skilled in the art, such as a microswitch or a capacity switch. Cap 11 includes a seal 15 at its base that in the illustrated first position in spaced form the bottom of pin 12.

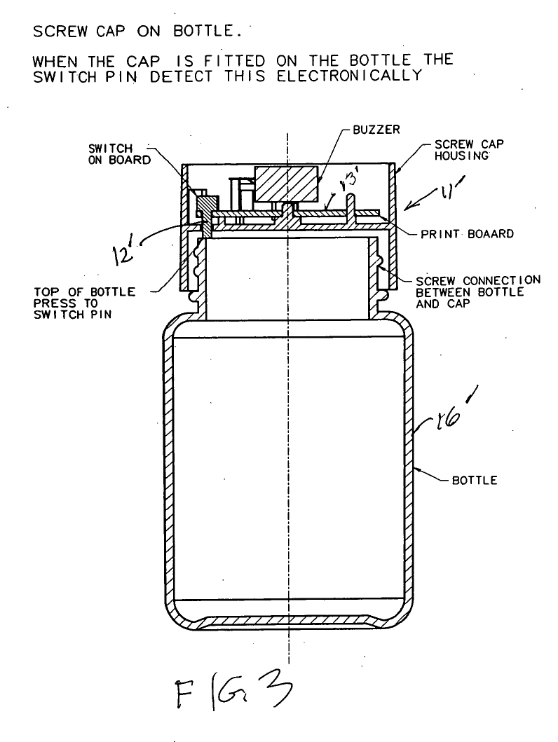

Referring to FIG. 2, there is shown a diametrical sectional view of the cap of FIG. 1 closing receptacle 16. With cap 11 closing receptacle 16, the top edge of receptacle 16 forces seal 15 upwards to move pin 12 upwards into a second position in housing 14 that is representative of cap 11 closing receptacle 16. In the position shown in FIG. 2, for example, with a microswitch, pin 12 may actuate the microswitch to close the microswitch that is not normally open in the first position shown in FIG. 1

Referring to FIG. 3, there is shown a diametrical sectional view of another embodiment of the invention showing a screw cap 11′ closing a receptacle 16′ in the second position with the pin 12′ near the perimeter of cap 11′ that is moved upward by the top of receptacle 16′ when cap 11′ is screwed on receptacle 16′ to actuate the switch on printed circuit board 13′. When cap 11′ is removed, pin 12′ descends from the actuator switch.

The switch is typically a single-pole single throw switch on the printed circuit board that typically has one terminal connected to an input pin of an integrated circuit (IC) on the printed circuit board that receives a signal representative of whether the cap is off or closing the receptacle and the other terminal connected to the negative terminal of the battery. Then when the switch is closed, this IC pin may draw current through the closed switch to signify the cap closing the receptacle. When the cap is off, the switch is open to signify the receptacle is not closed. The apparatus could be constructed and arranged so that open switch indicates cap closing the receptacle and closed switch indicating the cap does not close the receptacle.

There has been described a cap with a timing circuit and switch structure constructed and arranged to allow for reliable operation at low assembly cost in a more compact structure. It is evident that those skilled in the art may now make numerous uses and modifications of and departures form the specific apparatus and techniques herein disclosed without departing from the inventive concepts. Consequently, the invention is to be construed as bracing each and every novel feature and novel combination of features presented or posed by the apparatus and techniques herein disclosed and limited solely by the spirit and scope of the pending claims.

What is claimed is:

1. A cap for enclosing a medication receptacle having a timing circuit constructed and arranged for emitting a sensible signal when a predetermined time interval has elapsed sensitive to opening and closing the receptacle comprising,
a printed circuit board in said cap containing said timing circuit and a switch, and
a switch pin constructed and arranged to place said switch in a first position when off said receptacle and in a second position when closing said receptacle.

2. A cap in accordance with claim 1 wherein said switch pin has its axis coincident with the axis of said cap,
a switch housing on said printed circuit board accommodating an end of said switch pin,
and a seal at the bottom of said cap constructed and arranged to urge said switch pin upward in said switch housing when said cap closes said receptacle.

3. A cap in accordance with claim 1, wherein said switch pin is located near the perimeter of said cap constructed and arranged to engage the upper edge of said receptacle.

4. A cap in accordance with claim 3 wherein said cap may be screwably attached to said receptacle.
